(19) United States
(12) Patent Application Publication
(10) Pub. No.: US 2018/0144181 A1
(43) Pub. Date: May 24, 2018

(54) FINGERPRINT IDENTIFICATION MODULE

(71) Applicant: Primax Electronics Ltd., Taipei (TW)

(72) Inventors: MAO-HSIU HSU, Taipei (TW); KUAN-PAO TING, Taipei (TW)

(21) Appl. No.: 15/400,184

(22) Filed: Jan. 6, 2017

(30) Foreign Application Priority Data
Nov. 18, 2016 (TW) 105137892

(51) Int. Cl. G06K 9/00

(52) U.S. Cl. CPC G06K 9/00087; G06K 9/0002

(57) ABSTRACT

A fingerprint identification module is provided for identifying a fingerprint of a finger. The fingerprint identification module includes a circuit board, a sensing chip, a microprocessor and a piezoelectric element. The piezoelectric has a fingerprint sensing region to be pressed by the finger. When the fingerprint sensing region is pressed by the finger, the piezoelectric element generates a driving voltage. The electric power corresponding to the driving voltage is provided to the sensing chip and the microprocessor. Consequently, a fingerprint identification process is performed.

### FIELD OF THE INVENTION

The present invention relates to a fingerprint identification module, and more particularly to a fingerprint identification module with a piezoelectric element.

### BACKGROUND OF THE INVENTION

With increasing development of science and technology, mobile electronic devices such as smart phones or notebook computers become essential devices to people. Generally, most users spend several hours to use smart phones or notebook computers every day. As known, many important data are stored in the smart phones or the notebook computers. For achieving good confidentiality, fingerprint identification modules are developed and applied to electronic products for identity recognition.

For example, the commercially available mobile electronic device has a hibernation mode. If the mobile electronic device has not be used for a predetermined time period (e.g., 3 minutes), a display screen of the mobile electronic device is automatically turned off. That is, the mobile electronic device enters the hibernation mode. In the hibernation mode, the mobile electronic device stops sensing any signal that is inputted by the user. If the user wants to perform the fingerprint identification, the user has to press a key to wake up the mobile electronic device from the hibernation mode. After the mobile electronic device is waked up, the mobile electronic device provides electric power to the fingerprint identification module. Consequently, the fingerprint identification module is restored to the normal state to sense the fingerprint.

As mentioned above, the fingerprint identification module is unable to sense the fingerprint when the mobile electronic device is in the hibernation mode. For the user who performs the fingerprint identification, the process of waking up the mobile electronic device from the hibernation mode is redundant and unnecessary. That is, before the fingerprint identification module senses the fingerprint, an additional step (e.g., the step of pressing a key) is needed to have the mobile electronic device provide electric power to the fingerprint identification module. In other words, the conventional fingerprint identification module needs to be further improved.

### SUMMARY OF THE INVENTION

The present invention provides a fingerprint identification module. The fingerprint identification module can generate electric power in response to a pressing action of the user. The fingerprint identification module is powered by the self-generated electric power. Consequently, it is not necessary to wake up an electronic device with the fingerprint identification module when the electronic device is in a hibernation mode.

In accordance with an aspect of the present invention, there is provided a fingerprint identification module for identifying a fingerprint of a finger. The fingerprint identification module includes a circuit board, a sensing chip, a microprocessor and a piezoelectric element. The sensing chip is disposed on the circuit board and electrically connected with the circuit board. After the sensing chip senses the fingerprint, the sensing chip generates a fingerprint feature information. The microprocessor is disposed on the circuit board and electrically connected with the circuit board. The fingerprint feature information from the sensing chip is received by the microprocessor so as to be compared. The piezoelectric element is stacked over the sensing chip and the microprocessor and electrically connected with the circuit board. The piezoelectric has a fingerprint sensing region to be pressed by the finger. When the fingerprint sensing region is pressed by the finger, the piezoelectric element generates a driving voltage to drive the sensing chip and the microprocessor.

In an embodiment, the fingerprint identification module further includes a storage memory, and the storage memory is disposed on the circuit board. When the fingerprint sensing region is pressed by the finger, the piezoelectric element generates the driving voltage to drive the sensing chip, the microprocessor and the storage memory, and the sensing chip senses the fingerprint and transmits the fingerprint feature information to the microprocessor. The fingerprint feature information is compared with a fingerprint database in the storage memory.

In an embodiment, the sensing chip, the microprocessor and the storage memory are encapsulated through a land grid array (LGA) package structure or a ball grid array (BGA) structure.

In an embodiment, the piezoelectric element includes two pins. The two pins are located at a lateral edge of the piezoelectric element and electrically connected with the circuit board.

In an embodiment, the fingerprint identification module further includes a structure reinforcement plate, and the structure reinforcement plate is disposed under the circuit board. The circuit board and the structure reinforcement plate are combined together through an adhesive.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a fingerprint identification module according to an embodiment of the present invention;

FIG. 2 is a schematic perspective view illustrating the fingerprint identification module according to the embodiment of the present invention; and

FIG. 3 is a schematic cross-sectional view illustrating the fingerprint identification module according to the embodiment of the present invention.

### DETAILED DESCRIPTION OF THE PREFERRED EMBODIMENT

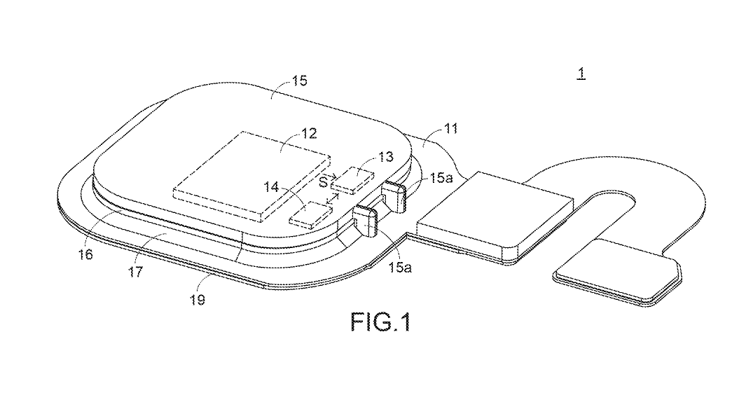

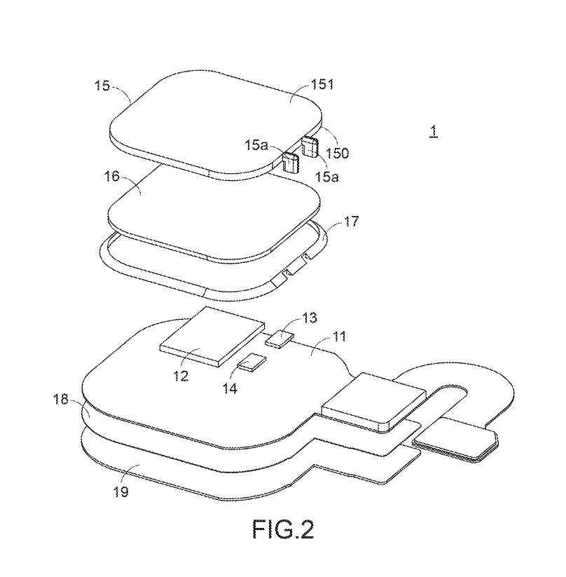

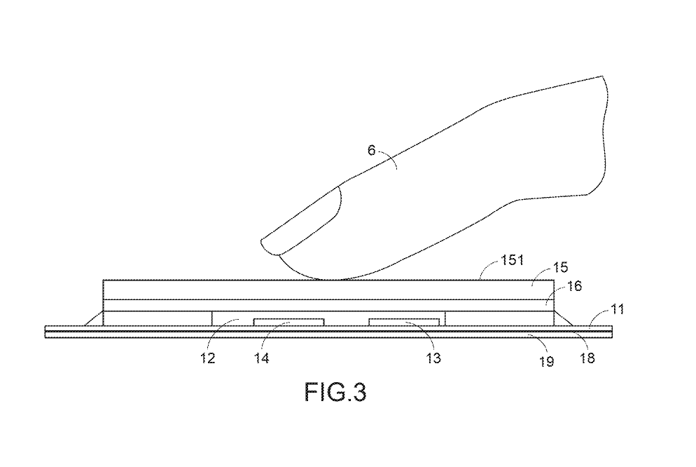

Please refer to FIGS. 1, 2 and 3. FIG. 1 is a schematic perspective view illustrating a fingerprint identification module according to an embodiment of the present invention. FIG. 2 is a schematic exploded view illustrating the fingerprint identification module according to the embodiment of the present invention. FIG. 3 is a schematic cross-sectional view illustrating the fingerprint identification module according to the embodiment of the present invention. The fingerprint identification module 1 is used for identifying a fingerprint of a user's finger 6 and judging whether the finger complies with the user privilege. In this embodiment, the fingerprint identification module 1 comprises a circuit board 11, a sensing chip 12, a microprocessor 13, a storage memory and a piezoelectric element 15. The sensing chip 12, the microprocessor 13 and the storage memory 14 are electrically connected with the circuit board 11 so as to exchange signals. Preferably, all of the sensing chip 12, the microprocessor 13 and the storage memory 14 are disposed on the circuit board 11.

The sensing chip 12, the microprocessor 13 and the storage memory 14 are encapsulated by a resin layer 16 through a land grid array (LGA) package structure, a ball grid array (BGA) structure or any other appropriate package structure. Preferably, a ring-shaped sealant 17 is arranged around the periphery of the junction between the resin layer 16 and the circuit board 11. The resin layer 16 is adhered on the circuit board 11 through the ring-shaped sealant 17. Moreover, by the ring-shaped sealant 17, foreign liquid or moisture is prevented from entering the space between the resin layer 16 and the circuit board 11.

The piezoelectric element 15 is stacked over the sensing chip 12, the microprocessor 13. That is, the piezoelectric element 15 is the outermost layer of the fingerprint identification module 1. Consequently, the piezoelectric element 15 can be pressed by the user's finger 6. The piezoelectric element 15 comprises a fingerprint sensing region 151. The fingerprint sensing region 151 is located at a top surface of the piezoelectric element 15. When the user's finger 6 presses the piezoelectric element 15, the fingerprint of the user's finger 6 faces the fingerprint sensing region 151.

The piezoelectric element 15 comprises two pins 15a. The two pins 15a are located at a lateral edge 150 of the piezoelectric element 15 and arranged side by side. Moreover, the piezoelectric element 15 is electrically connected with the circuit board 11. The piezoelectric element 15 is a dielectric element for converting mechanical energy into electric energy. When the piezoelectric element 15 is pressed by the user, a driving voltage is generated between two end surfaces of the piezoelectric element 15 in response to the applied pressure. The driving voltage can be used as an electric power source. The electric power corresponding to the driving voltage is provided to the sensing chip 12, the microprocessor 13 and the storage memory 14 through the circuit board 11. Consequently, the sensing chip 12, the microprocessor 13 and the storage memory 14 are enabled.

In an embodiment, the fingerprint identification module 1 is installed in a mobile electronic device. A function of the fingerprint identification module 1 is similar to a password inputting function. Through the fingerprint identification module 1, the mobile electronic device can be unlocked. In accordance with the present invention, the fingerprint identification module 1 comprises the piezoelectric element 15. While the fingerprint identification is performed and the external force of the user's finger 6 is exerted on the piezoelectric element 15, the piezoelectric element 15 generates the driving voltage. Since the driving voltage is used as the electric power source of the fingerprint identification module 1, it is not necessary to acquire electric power from the mobile electronic device. Consequently, the fingerprint identification module 1 can sense the fingerprint of the user's finger when the mobile electronic device is in the hibernation mode. After the fingerprint identification module 1 judges that the fingerprint is accurate, the mobile electronic device is waked up or powered on. Consequently, the operating process is simplified and the power consumption is reduced.

Moreover, while the piezoelectric element 15 is pressed by the user's finger 6, the fingerprint facing the fingerprint sensing region 151 is sensed by the sensing chip 12 under the piezoelectric element 15. That is, the sensing chip 12 generates a fingerprint feature information S according to the feature of the sensed fingerprint. The way of generating the fingerprint feature information is well known to those skilled in the art, and is not redundantly described herein.

Then, the fingerprint feature information S is transmitted to the microprocessor 13 for comparison. After the fingerprint feature information S is received by the microprocessor 13, the fingerprint feature information S is compared with a fingerprint data (not shown) in the storage memory 14 by the microprocessor 13. The fingerprint data contains the accurate fingerprint of the user that has been previously stored.

Moreover, the fingerprint identification module 1 further comprises a structure reinforcement plate 19. The structure reinforcement plate 19 is disposed under the circuit board 11. The circuit board 11 and the structure reinforcement plate 19 are combined together through an adhesive 18. Consequently, the overall structural strength of the fingerprint identification module 1 is increased. When the fingerprint identification module 1 is depressed by the user, the components of the fingerprint identification module 1 are not easily subjected to deformation or detached.

From the above descriptions, the present invention provides a fingerprint identification module. Since the fingerprint identification module comprises a piezoelectric element, the fingerprint identification module can generate electric power. That is, the fingerprint identification module does not need to acquire electric power from the electronic device. When the electronic device is in the hibernation mode, the fingerprint identification module can perform the fingerprint identification independently. After the fingerprint identification module judges that the fingerprint is accurate, the electronic device is waked up or powered on. Consequently, the operating process is simplified and the power consumption is reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A fingerprint identification module for identifying a fingerprint of a finger, the fingerprint identification module comprising:
a circuit board;
a sensing chip disposed on the circuit board and electrically connected with the circuit board, wherein after the sensing chip senses the fingerprint, the sensing chip generates a fingerprint feature information;
a microprocessor disposed on the circuit board and electrically connected with the circuit board, wherein the fingerprint feature information from the sensing chip is received by the microprocessor receives so as to be compared; and
a piezoelectric element stacked over the sensing chip and the microprocessor, and electrically connected with the circuit board, wherein the piezoelectric has a fingerprint sensing region to be pressed by the finger,
wherein when the fingerprint sensing region is pressed by the finger, the piezoelectric element generates a driving voltage to drive the sensing chip and the microprocessor.

2. The fingerprint identification module according to claim 1, wherein the fingerprint identification module further comprises a storage memory, and the storage memory is disposed on the circuit board, wherein when the fingerprint sensing region is pressed by the finger, the piezoelectric element generates the driving voltage to drive the sensing chip, the microprocessor and the storage memory, and the sensing chip senses the fingerprint and transmits the fingerprint feature information to the microprocessor, wherein the fingerprint feature information is compared with a fingerprint database in the storage memory.

3. The fingerprint identification module according to claim 2, wherein the sensing chip, the microprocessor and the storage memory are encapsulated through a land grid array (LGA) package structure or a ball grid array (BGA) structure.

4. The fingerprint identification module according to claim 1, wherein the piezoelectric element comprises two pins, wherein the two pins are located at a lateral edge of the piezoelectric element and electrically connected with the circuit board.

5. The fingerprint identification module according to claim 1, wherein the fingerprint identification module further comprises a structure reinforcement plate, and the structure reinforcement plate is disposed under the circuit board, wherein the circuit board and the structure reinforcement plate are combined together through an adhesive.
